(19) United States
(12) Patent Application Publication
(10) Pub. No.: US 2011/0010857 A1
(43) Pub. Date: Jan. 20, 2011

(54) CARDIOLOGY GURNEY

(76) Inventors: Michael G. Falbo, SR., Ft. Worth, TX (US); Martin Smoler, Mission Hills, KS (US)

Correspondence Address: POLSINELLI SHUGHART PC, 700 West 47th Street, Suite 1000, KANSAS CITY, MO, 64112, US

(21) Appl. No.: 12/505,336

(22) Filed: Jul. 17, 2009

(51) Int. Cl. A61G 13/10; A61G 13/06; A61G 13/04; A47C 21/08; A61G 13/12; A61G 7/00; A61G 1/02

(52) U.S. Cl. 5/601; 5/611; 5/614; 5/616; 5/617; 5/430; 5/621; 5/626

(57) ABSTRACT

A patient examination and transportation and echocardiography gurney is provided having side guard rails that protect the patient during transportation, the guard rails being repositionable to avoid obstruction of the access to the patient's chest during echocardiography procedures, the guard rails being selectably positionable to support the patient during echocardiography procedures.

### FIELD OF THE INVENTION

The field of the invention relates to patient transport gurneys and patient examination tables. In particular, the present device is a patient transport gurney having an openable filler or drop-down section that exposes an opening or void in the patient support surface for conducting echocardiography examinations of patients. The device is provided with horizontally repositionable side guard rails that can be shifted laterally away from the void created by releasing the filler or drop-down section to allow an ultrasound transducer or sonde to be applied to a patient's chest wall during echocardiography examinations of the patient.

### BACKGROUND OF THE INVENTION

In attending to of patients complaining of chest pain or exhibiting signs of a heart attack, it is necessary for hospital staff to immediately proceed to diagnose the patient's medical condition. The medical personnel must act rapidly as many treatments for heart attack are best provided within a finite period of time after the cardiac event. Increasingly, hospitals are finding that having efficient cardiac diagnostic related devices that enhance the rapidity of dealing with the diagnosis of cardiac events is beneficial.

One such cardiac examination that is performed with high frequency during presentations of cardiac events is the ultrasound sonography of the heart or the echocardiography examination of the heart. To perform echocardiography, it is necessary, for at least some of the examination, that the patient be rotated off their back and onto their side and positioned in a manner that allows access to the patient's chest wall adjacent the heart so the echocardiography transducer or sonde may be applied to the patient's chest wall. The positioning of a patient for an echocardiography procedure necessitates the patient being positioned at the edge of the examination table or, alternatively, positioned over an opening or a void created by the opening of a filler section or a drop down section in an echocardiography examination table. A better understanding of the structure and use of such filler or drop down sections may be found in U.S. Pat. No. 5,184,363 and Des. 347,691 and U.S. Pat. Nos. 5,461,739 and 5,919,131 and 5,950,262 and 6,353,949 and 7,032,263 which show tables having drop down sections for use in echocardiography examinations of patients. The specifications of U.S. Pat. No. 5,184,363 and Des. 347,691 and U.S. Pat. Nos. 5,461,739 and 5,919,131 and 5,950,262 and 6,353,949 and 7,032,263 are incorporated herein by reference.

Therefore, to promote efficient rapid treatment of a patient experiencing a cardiac, it would be a great advantage to have a device that can act as a patient transport device, and an echocardiography table which will allow a wide range of medical activities and procedures to be performed on the patient. It would be a further advantage to avoid needless shifting of the patient from a bed to a gurney and to an echocardiography table and back to the gurney then back to the patient bed and then back to the gurney for transport into a cardiac catheterization procedure suite where the cardiologist can perform more advanced procedures on the patient. Yet another benefit of the present device is the provision of guard rails that can be raised and lowered to retain a patient on the gurney and which can be laterally repositioned to allow unobstructed access to an opening or a void for conducting echocardiography procedures and which rails can be laterally repositioned for such unobstructed access while also in their raised position to allow a sedated or semiconscious patient to be safely positioned on their side near the edge of the table during the conduct of an echocardiography procedure.

### SUMMARY OF THE INVENTION

A patient gurney is provided for use in cardiology-related emergency situations. The gurney is equipped with filler or drop sections within the patient bed area which, when open or removed provide an opening or void that is useful in conducting echocardiography examinations of patients who have presented themselves with complaints of chest pains or heart attack symptoms or other cardiology related issues. The cardiology gurney is particularly suited for emergency cardiology situations as the patient can be placed on the cardiology gurney and subsequently moved about the hospital to receive various cardiology-related tests and examination without the need to shift the patient from a standard gurney onto an echocardiography table for an examination followed by subsequent return to a gurney for transport back to other areas of the hospital.

The cardiology gurney is provided with means for adjusting the support surface height such as hydraulic or pneumatic cylinders or electric or mechanical drives to permit the patient support surface of the echocardiography gurney to be raised or lowered to the height of an operating table in a hospital catheterization lab for additional examination of the patient's vasculature and heart blood vessels.

The cardiology gurney further is provided with the left side and right side safety rails which are moveable between a raised guard rail position and collapsed non-obstructive position along the side of the patient support surface to allow access to the patient support surface. In addition, the guard rails, in either collapsed or upright position, are, laterally repositionable and may be moved in the direction of the head end and the foot end of the cardiology gurney. This movement permits the guard rails to be positioned in a manner to best retain the patient on the bed surface and positioned so they may avoid obstructing the use of the opening or void presented by the removal or movement of the filler section or drop section when the cardiology gurney is used for echocardiography procedures. Also, the guard rails may be used in the upright position during echocardiography to retain the patient on the bed while the guard rails are laterally repositioned to leave the opening used for echocardiography unobstructed. These features and others will become apparent in the following detailed description.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of the invention may be employed without reference to other features and subcombinations. Other objects and advantages of this invention will become apparent from the following description taken in connection with the accompanying drawings, which set forth by illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a perspective view of an embodiment showing the patient support surface flat and the drop section in the upward position and both guard rails in their upward and forward position to prevent the patient from falling off the gurney;

FIG. 2 is a perspective view of the embodiment of FIG. 1 showing the left side guard rail in the collapsed or down position and the right side rail in the up position and with both rails laterally positioned toward the middle of the gurney;

FIG. 3 is a perspective view of the embodiment of FIG. 1 showing the filler or drop section in the down position or removed position to expose the opening or void and with the left side guard rail collapsed and shifted towards the foot of the bed to provide unobstructed access to the opening or void presented by the left side drop section and the right side rail in the up position and moved toward the foot of the bed to provide unobstructed access to the head end of the right side;

FIG. 4 is an elevation view of the left side guard rail in a nearly fully collapsed position and showing the lateral sliding rail release pin 54 and the post locking release lever 38;

FIG. 5 shows the embodiment of FIG. 1 with the head end section 16 of the device elevated and the filler or drop section 18 in the raised position or inserted position and the guard rails in the upward position;

FIG. 6 is a perspective view of the embodiment of FIG. 1 with a patient positioned thereon for transport and showing the filler or drop section in the raised or inserted position and with both guard rails in the raised and middle position to prevent the patient from falling from the gurney during transport procedures;

FIG. 7 is a perspective view of the embodiment of FIG. 1 with a patient positioned thereon and on his side in preparation for a cardiology procedure and showing the filler or drop section in the raised or inserted position and with both guard rails in the raised and middle position to prevent the patient from falling from the gurney and with the left side guard rail being made available to the patient by its middle position to assist the patient in pulling himself onto his side and to allow the patient to hold himself on his side during the preparation for a cardiology procedure;

FIG. 8 is a perspective view of the embodiment of FIG. 1 with a patient positioned on his side in preparation for a cardiology procedure and showing the filler or drop section in the lowered or removed position and with both guard rails in the raised and middle position to prevent the patient from falling from the gurney and with the left side guard rail being made available to the patient by its middle position to allow the patient to hold himself on his side during the preparation for a cardiology procedure;

FIG. 9 is a perspective view of the embodiment of FIG. 1 with a patient positioned on his side in preparation for a cardiology procedure and showing the filler or drop section in the lowered or removed position and with both guard rails in the raised and with the right side guard rail in the middle position to prevent the patient from falling from the gurney and with the left side guard rail laterally shifted toward the foot end section to leave the opening or void unobstructed while still being within reach of the patient to allow the patient to hold himself on his side during the cardiology procedure;

FIG. 10 is a right side elevation view of the lower rail of the left-side guard rail and showing the slide bearing and the slide rail captured therein; and

FIG. 11 is a perspective view of a fragment of the embodiment of FIG. 1 showing the drop section in the lowered or removed position and with the left side guard rail in the middle position showing the obstruction presented by the lower rail during an attempt to access the chest of a patient in the void to apply an echocardiograph sonde to the patient's chest.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

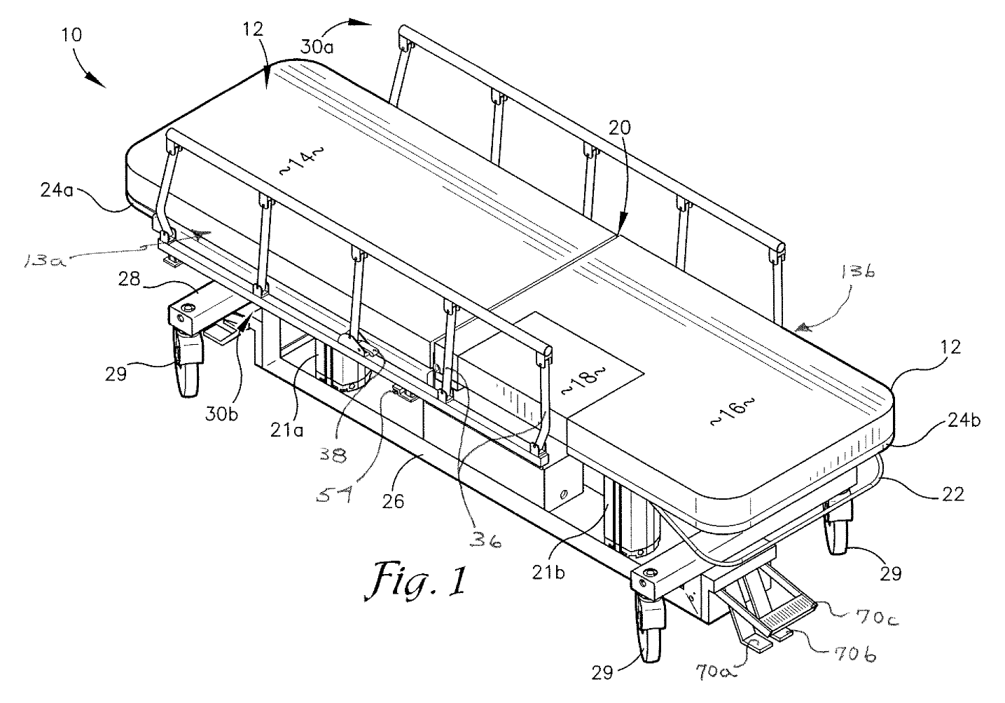

Referring now to FIG. 1, cardiology gurney or patient support apparatus 10 is shown in a top, head end and left side perspective view. Cardiology gurney 10 is comprised of the following general sections; patient support surface 12 having foot end section 14 and head or head section 16 and patient support surface opposed sides comprising left side 13a and patient support surface right side 13b. Head section 16 is provided with echocardiography filler or drop section 18 which is shown in the upward or closed or inserted position in FIG. 1. It will be appreciated that support surface foot end section 14 is separated from support surface head section 16 by space 20 which is provided to accommodate the raising and lowering of bed surface head section 16 through the use of head section means for adjusting the height 21b which is controlled by head section elevation control bar 22. Cardiology gurney 10 is provided with a two-section support frame 24 having a first support frame section 24a supporting foot end section 14 and a second support frame section 24b supporting head section 16. Support frame 24 also is comprised of first and second opposed sides, left side 25a and right side 25b. Support frame sections 24a, 24b are pivotally joined at the location of space 20 to permit the upward and downward pivotal movement of head section 16 with respect to foot end section 14.

Cardiology gurney 10 provides a mobile patient support having filler or drop section 18 to permit the conduct of echocardiography examinations on patients. This is accomplished while avoiding additional shifting of movement of the patient from a standard hospital gurney to an echocardiography table, with or without drop sections. It also should be appreciated that a patient on cardiology gurney 10 is likely to be in a sedated or confused or disoriented state. Alternatively, the patient may be completely unconscious. For these reasons, the provision of guard rails 30a, 30b on cardiology gurney 10 is important for providing patient safety and also for enabling echocardiography examinations to proceed while providing for a patient's safety when the patient is in a sedated, unconscious or agitated state. The function of the guard rails will be described hereinafter.

Cardiology gurney 10 has support base member 26 which extends beneath support frame 24 generally along the longitudinal axis of cardiology gurney 10. At either end of support base member 26 are cross members 28 which support base member 26 above the ground as well as the entirety of cardiology gurney 10 on casters or wheels 29. It will be appreciated that wheels 29 provide for complete mobility of cardiology gurney 10 and are provided with a locking or breaking mechanism (not shown) to fix the gurney in a selected location and to prevent unintended movement of the cardiology gurney 10.

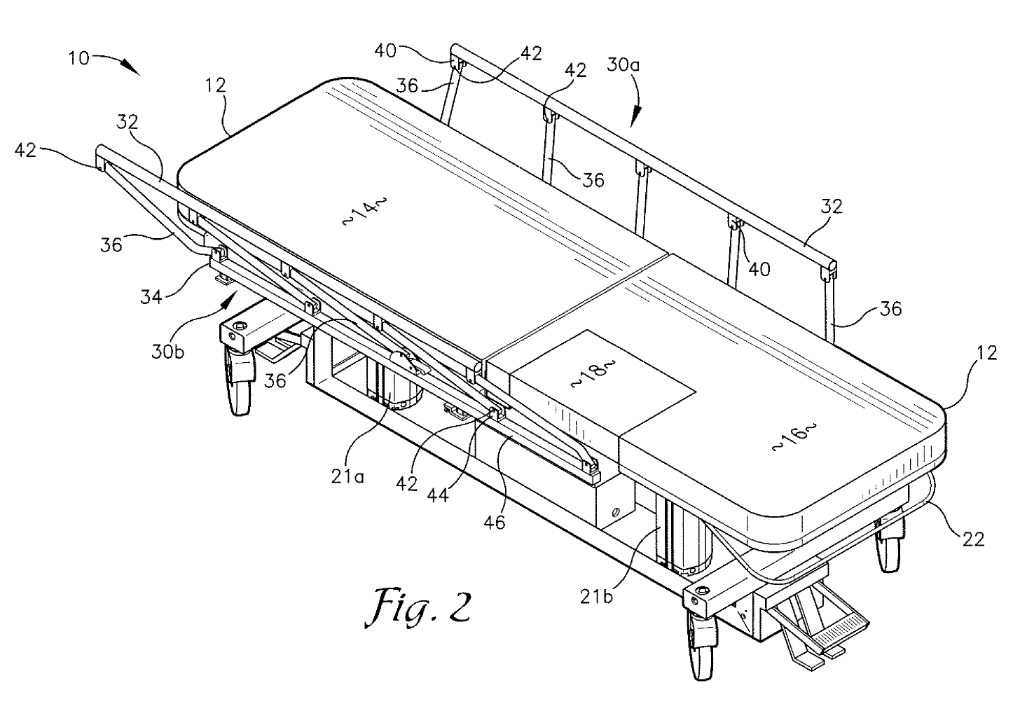

Referring now to FIG. 2, the components of the guard rail system will be described. Guard rails 30a, 30b are positioned on either side of patient support surface 12 of cardiology gurney 10. As previously mentioned, the patient placed on cardiology gurney 10 often is sedated, delirious or unconscious, and it is necessary to ensure that the patient will not inadvertently fall from patient support surface 12 and become further injured. Guard rails 30a, 30b act to prevent such an unwanted departure of the patient from support surface 12. Guard rails 30a, 30b are generally comprised of a top rail 32 which is supported on a bottom rail 34 by two or more posts 36, each post 36 having a first end 36a and a second end 36b. Guard rails 30a, 30b are selectably repositionable in both an upright guard rail position (30a of FIG. 2) and in a collapsed, bed surface accessing position (30b, FIG. 2). Guard rails 30a, 30b are constructed so they can be shifted by the hospital attendant from the upright position of guard rail 30a into a non-obstructing position such as that shown by guard rail 30b. Typically, in prior art guard rails, the guard rail itself might or might not collapse, but would move vertically downwardly below the top surface of patient support surface 12 either by vertically sliding downwardly or by folding or pivoting downwardly. In this manner, access to the patient support surface 12 was achieved. However, the present apparatus cannot operate in either such fashion or the utility of the apparatus will be destroyed. Specifically, if the guard rails simply shifted vertically downwardly, or collapsed while remaining in a middle position that obstructed entry into the drop section area, the support surface 12 would be accessable, but access to the drop section opening or void 50 of head section 16 would be obstructed by the presence of the flattened or vertically shifted guard rail. Such a circumstance would disable the ability of the cardiologist or sonographer to usefully employ the drop section 18 and associated opening or void 50 in executing echocardiography studies of the patent's heart. Such obstruction is shown in FIG. 11, wherein a sonographer is shown attempting to place her arm 63 into the opening or void 50 upon opening of the filler or drop section 18 however movement is obstructed by the presence of guard rail bottom rail 34. To avoid this unacceptable circumstance, the present apparatus is provided with guard rails 30a, 30b which allow the top rail 32 to collapse onto the bottom rail 34 and also allow the entire guard rail 30a, 30b to shift laterally from head to toe thereby allowing access to both the patient support surface 12 and to the area underneath patent support surface 12. The manner of this collapsing of guard rails 30a, 30b now will be described.

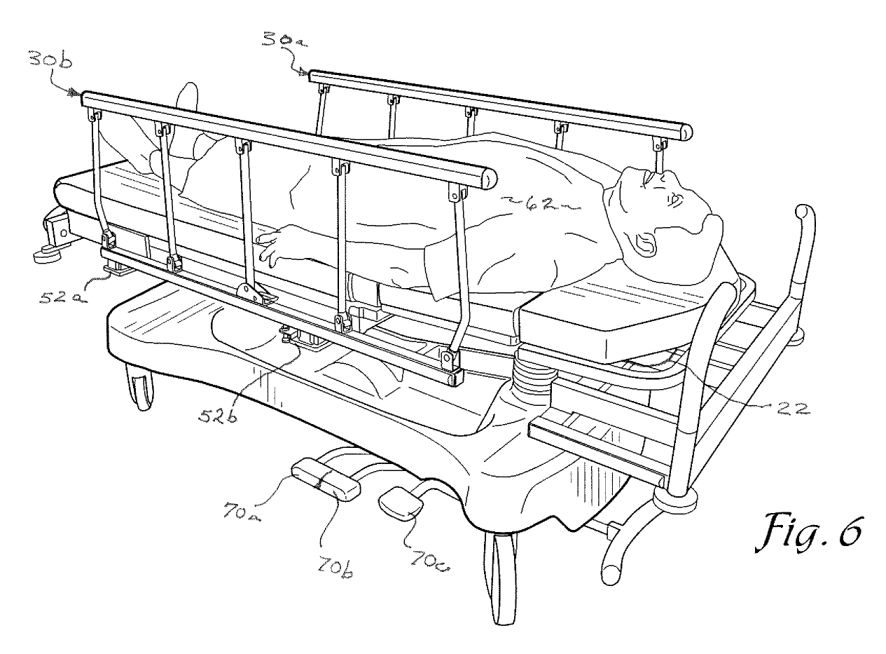

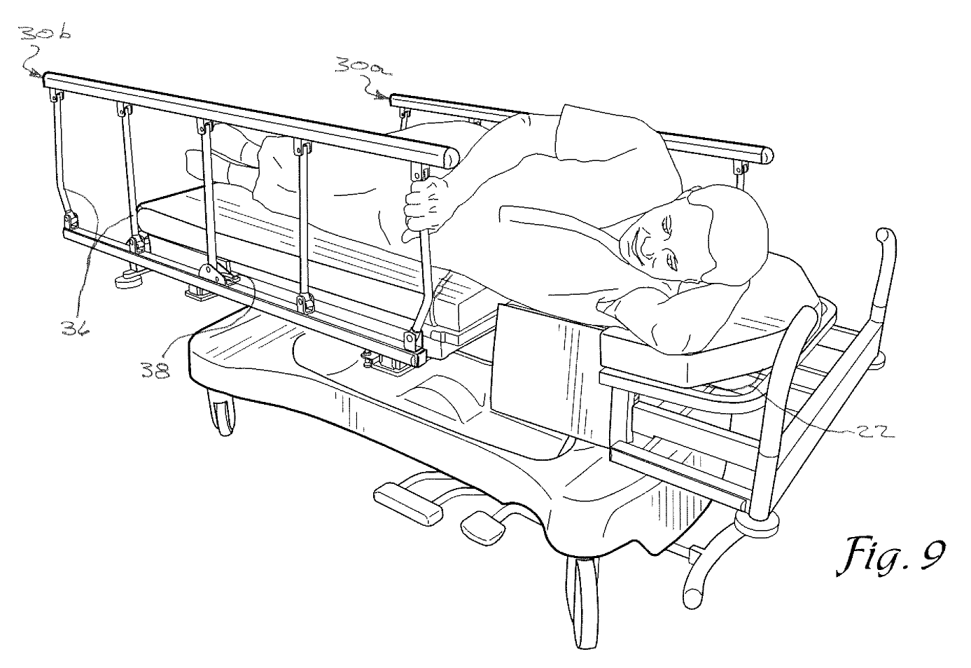

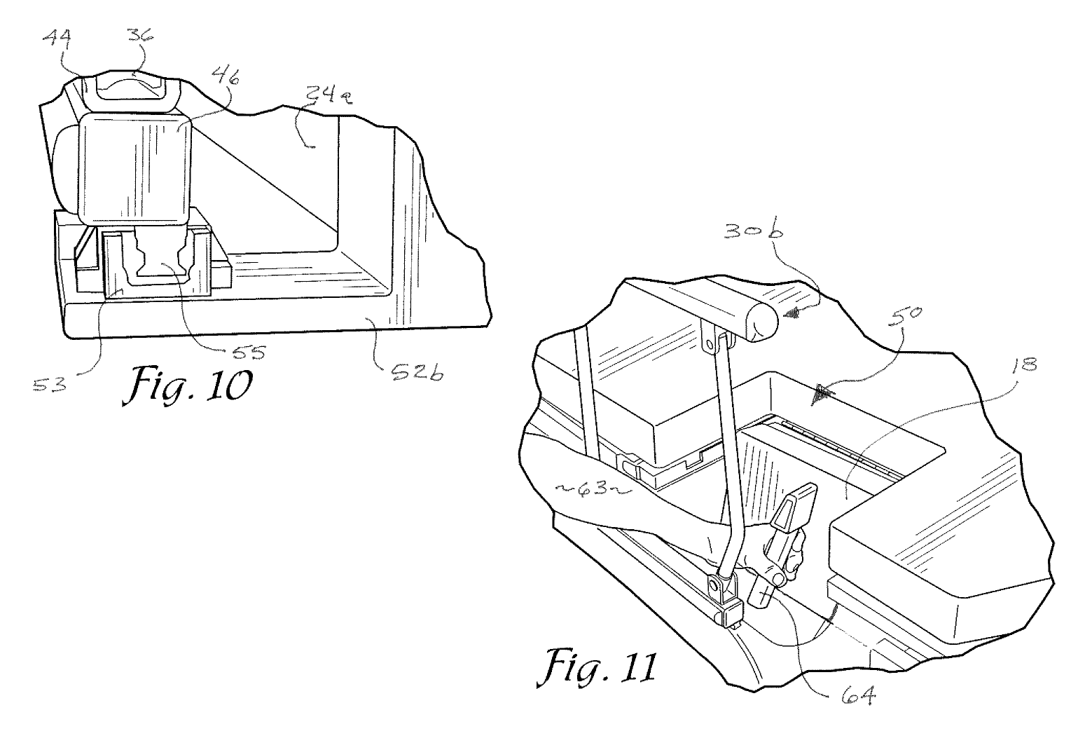

When it is desired to protect and retain a patient 60 (FIG. 6) on support surface 12, both guard rails 30a, 30b will be in the upright position as shown in FIG. 6. When it is desired to have access to the patient support surface 12, one or both of guard rails 30a, 30b can be collapsed and/or laterally shifted to provide unobstructed access to patient support surface 12 as is shown by guard rail 30b in FIG. 2 and FIG. 9. The rail collapsing procedure is accomplished by releasing post locking release lever 38 which then allows the pivot connection between posts 36 and each of top rail 32 and bottom rail 34 to allow said top rail 32 to collapse toward said bottom rail 34. This pivotal movement of each post 36 is accomplished by top rail flange 40 which is joined to post 36 by pivot pin 42. Pivot pin 42 passes through top rail flange 40 and through post 36 and is secured on the opposite side of top rail flange 40 such that pin 42 is not inadvertently removable, but provides for free rotation of post 36 about pin 42.

Similarly, the bottom of each of posts 36 is connected to bottom rail 34 by bottom rail flange 44 having the pivot pin 42 passing through a first side of flange 44 and passing through post 36. The pin 42 being secured on the second side of bottom rail flange 44 to permit pivotal movement of the bottom of post 36 with respect to bottom rail 34. To buffer the impact of posts 36 against bottom rail 34 of each of guard rails 30a, 30b, may be provided with a bumper (not shown) attached to each post 36 to mitigate the impact of each post 36 against bottom rail 34 and to reduce noise. It will be appreciated that post locking means 38 can be a pin which is inserted into a void passing through one of posts 36 and the associated flange 40, 44 or, alternatively, post locking means 38 could be a U-shaped flange which captures a post 36 between the legs of the U to prevent pivotal movement of the post and prevent collapsing of top rail 32 and posts 36 against bottom rail 34.

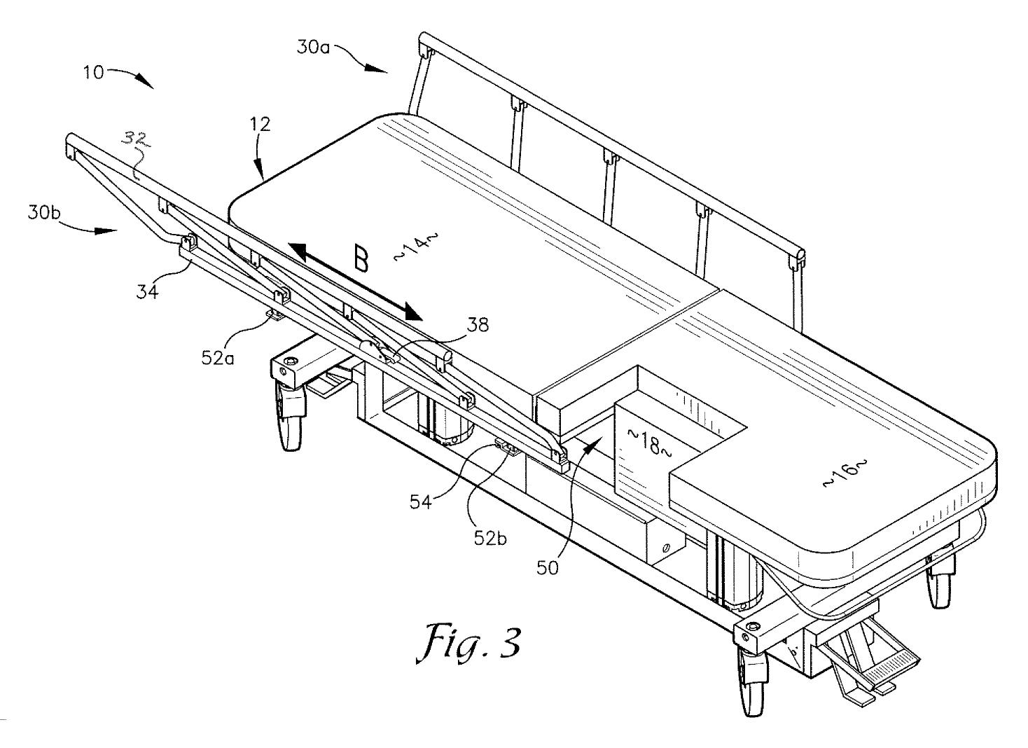

Referring now to FIG. 3, the slidable action of each of guard rails 30a, 30b will be discussed. As shown in FIG. 3, guard rail 30b is in the collapsed position with top rail 32 just below the top of patient support surface 12. As previously described, it is an object of guard rails 30a, 30b to be positionable and repositionable to maintain the patient 62 on the patient support surface 12 of cardiology gurney 10. To effectively perform this function, guard rails 30a, 30b should be generally centrally positioned with respect to the midline, approximately near space 20, of the longitudinal axis of cardiology gurney 10. However, also as previously described, it is necessary that guard rails 30a, 30b be laterally repositionable or moveable—that is guard rails 30a, 30b are moveable parallel to the longitudinal axis of cardiology gurney 10—to allow opening or void 50 to be fully accessible when filler section or drop section 18 (FIG. 1) is removed or hingedly swung downwardly or upwardly or rotated outwardly to provide void 50. As is shown in FIG. 3, drop section or filler section 18 has been hingedly lowered to present void 50.

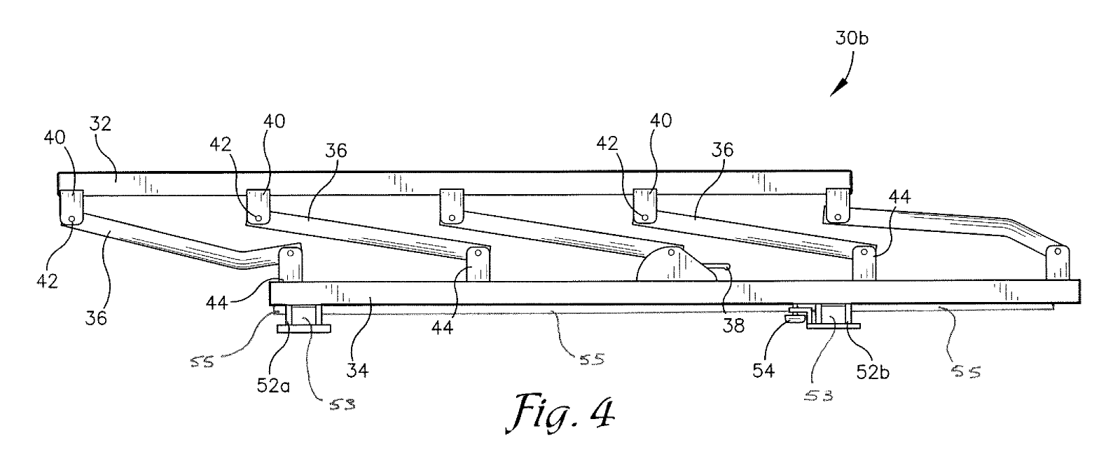

Again considering the lateral sliding function of guard rails 30a, 30b, guard rail 30b is shown in its collapsed position in FIG. 3. Guard rail 30b is attached to the side of gurney 10 by the capture of slide rail 55 (FIG. 4) by slide bearing 53 (FIG. 4) which is attached to connecting flanges 52a, 52b (FIG. 4). Slide rail 55 extends from bottom rail 34 and slide rail 55 is supported in slide bearing 53 to permit slidable movement of slide rail 55 therethrough to allow the lateral displacement of bottom rail 34 and of guard rail 30b. In a preferred embodiment, connecting flange 52b is provided with slide rail release 54 which is a spring biased pin that is insertable into a void in bottom rail 34 and operates to prevent lateral movement of bottom rail 34. The spring biasing of slide rail release pin 54 permits the retaining of pin 54 in holes or voids (not shown) situated along the length of bottom rail 34. In this fashion, pin 54 can be pulled downwardly to release pin 54 from insertion into a void whereupon bottom rail 34 is free to slide within slide bearing 53 in the directions shown by Arrow B (FIG. 3). It will be appreciated that release of pin 54 from insertion into a void permits guard rails 30a, 30b to be laterally moved parallel to the longitudinal axis of cardiology gurney 10. This allows guard rails 30a, 30b to either be generally centered with respect to the midline of cardiology gurney 10 (a midline transverse to the longitudinal axis of gurney 10) and alternatively, to allow guard rails 30a, 30b to be slidably moved laterally towards foot end section 14 of patient support surface 12 to provide unobstructed access to opening or void 50 of head section 16 of patient support surface 12.

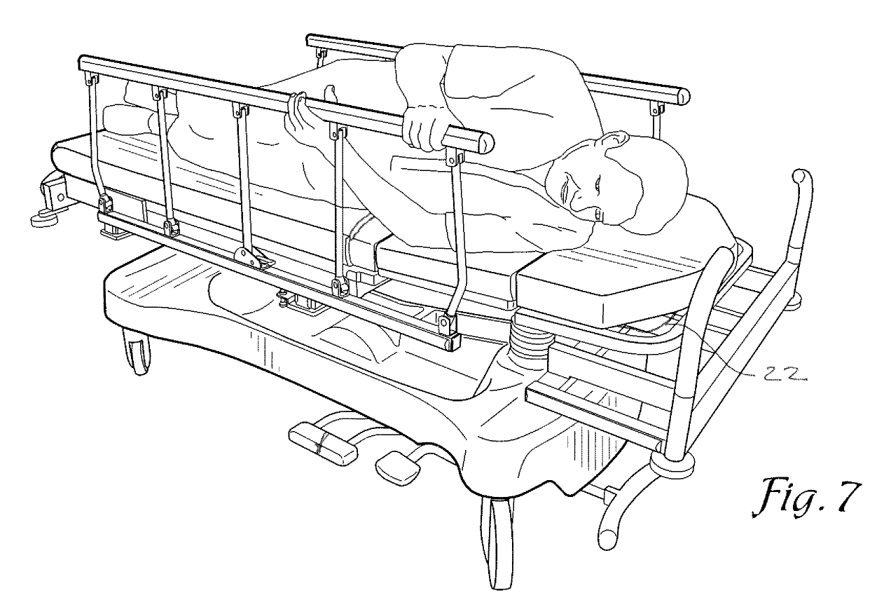

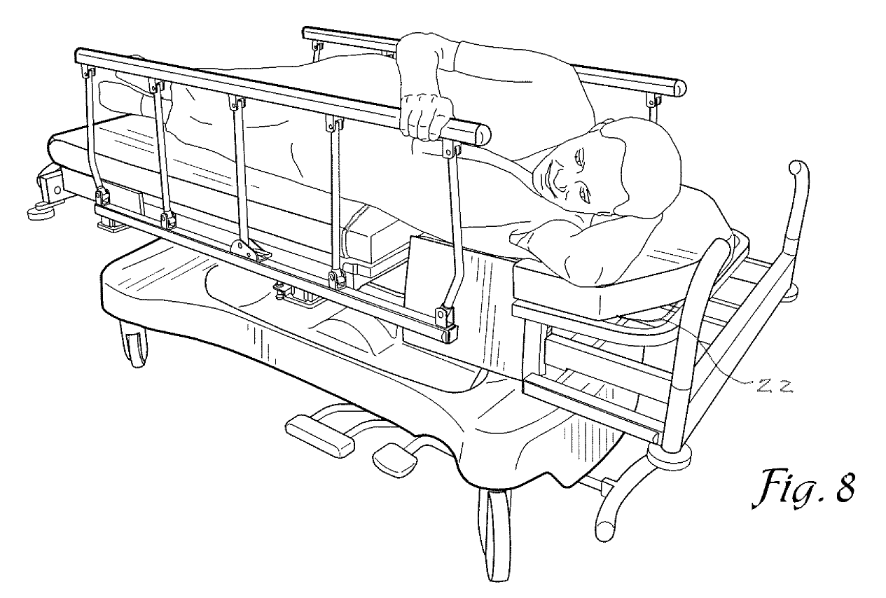

Again referring to FIG. 1, it will be appreciated that guard rail 30a, 30b also are laterally slidable while it is in the upright position, shown by comparison of FIGS. 1 and 7 and 9, as well as when guard rails 30a, 30b are in the collapsed position as shown by comparison of FIGS. 2 and 3. As previously mentioned, patients in need of cardiology care often will be in an unconscious or sedated or delirious state and will be incapable of retaining themselves on their side near the edge of a bed or a gurney safely. The present cardiology gurney 10, due to its laterally shiftable guard rails 30a, 30b, provides both patient support and patient safety heretofore unavailable in other guard rail devices. This is particularly important because during an echocardiography procedure, a patient must be, for some portions of the procedure, resting on their side either at the edge of a support surface or, in a table equipped with drop down sections, over the void provided by the drop down section as shown in FIGS. 7, 8 and 9). A patient that is debilitated through unconsciousness or sedation, or a patient that is disoriented is not capable of placing themselves on their side and certainly cannot be expected to safely remain near the edge of a bed or echocardiography table. The present cardiology gurney, however, is provided with laterally shiftable and repositionable guard rails 30a, 30b which, if necessary, can be maintained in the upright position as shown in FIGS. 7 and 8 while being shifted laterally to make unobstructed and accessable for use substantially all of opening or void 50 that is provided for an echocardiography examination when filler or drop section 18 is removed and the patient is placed on their side over opening or void 50 (FIGS. 8 and 9). It further will be appreciated that, with conventional guard rails which are vertically shiftable, the guard rail is either up and obstructing the echocardiography examination, or it is collapsed and cannot provide for patient safety, or it is shifted vertically downwardly where it is unavailable to support the patient or protect the patient from falling from the edge of the bed while the echocardiography procedure is performed. Further, it will be appreciated that when the conventional guard rail is collapsed or shifted vertically downwardly, that it will be obstructing the sonographer's access to the patient's body. Therefore, the guard rails of the present device avoid these limitations of previous guard rails while allowing for the performance of echocardiography procedures and while permitting maximum patient safety to be obtained during the conduct of an echocardiography procedure.

Referring now to FIG. 3, cardiology gurney 10 is shown with guard rail 30b in the collapsed position and with filler or drop section 18 in the down position exposing opening or void 50 for use by a sonographer during an echocardiography examination. It will be appreciated that with guard rail 30b in the down position and guard rail 30b laterally shifted toward foot end section 14 that patient support surface 12 is entirely accessible from the left side. Further, with filler section or drop section 18 in the down position to expose opening or void 50 that cardiology gurney 10 can act in a manner of an echocardiography examination table. The arrangement shown in FIG. 4 allows the sonographer to approach the patient from the same side and apply the transducer to the patient's chest wall through opening or void 50. In contrast, as shown in FIG. 11, a guard rail that is not laterally shiftable remains positioned directly within the line of access to opening or void 50 an obstructs the sonographer's ability to apply sonde 64 to the chest wall of the patient thereby compromising the quality of the echocardiogram. The present embodiment, as shown in FIGS. 3 and 9, provides the ability to maintain patient safety by providing a guard rail 30b in position during the echocardiography procedure while at the same time being repositionable to a location that does not obstruct the use of opening or void 50 by the sonographer.

Referring now to FIG. 4, an elevation view of guard rail 30b in its collapsed position is shown. The construction of guard rail 30b can be seen in detail as being comprised of bottom rail 34 having slide rail 55 extending therefrom. Slide rail 55 is fitted into slide bearings 53 which are mounted in connecting flanges 52a, 52b for slidable lateral repositioning of bottom rail 34 and guard rail 30b. The lateral sliding of bottom rail 34 is permitted by the user pulling outwardly on rail release pin 54 to pull the pin attached to rail release pin 54 from a void on the length of bottom rail 34. Once bottom rail 34 is released, slide rail 55 can freely slide within slide bearings 53 and guard rail 30b can be placed in a user selected position along the side of cardiology gurney 10. To configure guard rail 30b from its elevated position as is shown by guard rail 30a, (FIG. 3) the user will grasp top rail 32 and pushes downwardly on top rail 32 while depressing post locking release lever 38. Top rail 32 will exert a force on posts 36 which will pivot on pivot pins 42 which connect posts 36 to bottom rail flange 44 and to top rail flanges 40. It will be appreciated that whether rail 30a, 30b is in its lowered position or its upright position, it is laterally shiftable by the user through the use of rail release pin 54 as previously described.

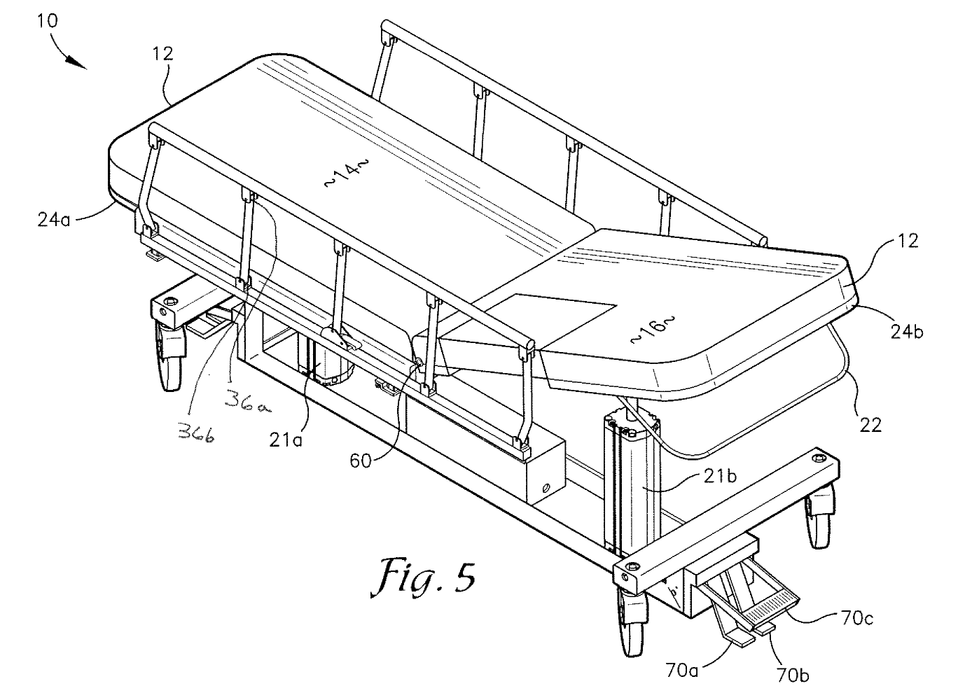

Referring now to FIGS. 1 and 5, patient support surface 12 may be raised and lowered through the use of the means for adjusting the height of the patient support surface 21a, 21b. The means for adjusting the height 21a, 21b may be a hydraulic cylinder or a pneumatic cylinder or may be an electrically motivated device such as a scissors jack or a screw mechanism or other mechanically extendable and retractable shaft that is suitable for use in a hospital environment. By depressing both pedals 70a, 70b simultaneously, the entire patient support surface 12 may be raised as both means for adjusting the height of the patient support surface 21a, 21b are thereby activated. It will be appreciated that support surface head end 16 is independently movable with respect to support surface foot end 14 and may be pivoted upwardly by use of pedal 70b to activate means for adjusting the height of the patient support surface 21b. Similarly, support surface foot end 14 may be individually pivoted upwardly by use of pedal 70a to activate means for adjusting the height 21a of the patient support surface. The selective operation of means for adjusting 21b for pivoting support surface head end 16 also is achieved through use of head section elevation control bar 22 that selectably operates means for adjusting the height 21b.

Still referring to FIG. 5, cardiology gurney 10 is shown with head section 16 in an elevated position with respect to foot end section 14. Head end section 16 has been raised by the operator pressing on head section elevation control bar 22 which activates means for adjusting the height 21b to raise head section 16 pivotally with respect to foot end section 14. Frame pivot means 60 is shown connecting support frame 24a of foot end section 14 to frame section 24b supporting head section 16. The operator, by lifting upwardly on head section elevation control bar 22, can release means for adjusting the height 21b and allow head end section 16 to pivotally rotate downwardly until it is again co-planar with foot end section 14.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive cardiology gurney is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is as follows:

1. A patient support apparatus comprising:
a patient support surface having a foot end and a head end and first and second opposed sides,
a frame for holding said support surface thereon said frame having first and second opposed sides and opposed ends,
a base member supporting said frame and having connected thereto first and second cross members having wheels attached thereto,
at least one opening in said support surface head end said opening positioned to be adjacent to the chest of a patient, said opening extending outwardly generally from a longitudinal midline of the patient support surface head end and said opening terminating at said first side of said patient support surface,
a removable filler section for insertion in said opening to provide a generally continuous patient support surface,
means for adjusting the height of said patient support surface above said base member,
a guard rail mounted adjacent said opening, said guard rail comprising:
a generally horizontal bottom rail,
a generally horizontal top rail,
a plurality of posts connecting said bottom rail and said top rail in spaced relation, and
a pivot connection between said post first end and said bottom rail and between said post second end and said top rail to provide collapsible movement of said top rail and said posts against said bottom rail,
a slide rail extending from said bottom rail, for capture in said bearing
at least one slide bearing connected to said frame, said slide rail captured in said slide bearing for slidable movement of said slide rail in a direction parallel to the longitudinal axis of said apparatus,
a release pin for securing said bottom rail in a selected position with respect to the longitudinal axis of said apparatus, and
a release lever for retaining said top rail and said posts in a upright relation to said bottom rail and for releasing said pivot connection to permit collapsible movement of said top rail and said posts against said bottom rail.

2. The apparatus as claimed in claim 1 wherein said means for adjusting the height of said patient support surface is a hydraulic cylinder or a pneumatic cylinder or a screw or scissors jack or an electrically operated extension and retraction device.

3. The apparatus as claimed in claim 1 wherein said support surface foot end and said support surface head end are separate sections and said frame for mounting said support surface is comprised of a frame foot section for supporting said support surface foot end and a frame head section for supporting said support surface head end said frame sections being pivotally connected for pivotal movement of said head section relative to said foot section.

4. The apparatus as claimed in claim 3 wherein said support surface foot end and said support surface head end are pivotally connected.

5. The apparatus as claimed in claim 4 wherein said support surface head end is connected to a means for adjusting the height of said patient support surface.

6. The apparatus as claimed in claim 5 wherein said means for adjusting the height is a hydraulic cylinder or a pneumatic cylinder or an electrically operated extension and retraction mechanism.

7. The apparatus as claimed in claim 1 wherein said filler section is pivotally attached to said frame.

8. A method of attending to a patient suspected of having a heart attack or other emergency cardiac event the method comprising:
placing the patient on a patient support surface said support surface having a foot end and a head end and first and second opposed sides, and a frame for mounting said support surface thereon said frame having first and second opposed sides, said frame supported by a base member having first and second cross members having wheels attached thereto,
providing at least one opening in said support surface head end said opening positioned to be adjacent to the chest of a patient, said opening extending outwardly generally from a longitudinal midline of the patient support surface head end and said opening terminating at said first side of said patient support surface,
shifting laterally a guard rail mounted adjacent said opening, said guard rail comprising
a bottom rail and a top rail connected to said bottom rail by two or more posts, said posts being pivotally connected to said bottom rail and pivotally connected to said top rail for collapsible movement of said top rail and said posts against said bottom rail,
a slide rail extending from said bottom rail, for capture in said bearing
at least one slide bearing for slidable support of said slide rail, said slide bearing permitting slidable movement of said slide rail parallel to a longitudinal axis of said support surface,
a release pin for securing said bottom rail in a selected position with respect to the longitudinal axis of said apparatus, and
a release lever for retaining said top rail and said posts in a upright relation to said bottom rail and for releasing said pivot connection to permit collapsible movement of said top rail and said posts against said bottom rail,
removing from said opening a filler section,
applying through said opening an echocardiography transducer to the chest wall of the patient; and
conducting an echocardiography procedure on the patient.

9. A guard rail for use with a patient support surface having first and second sides, the guard rail comprising:
a bottom rail and a top rail connected to said bottom rail by two or more generally vertical posts, said posts being pivotally connected to said bottom rail and to said top rail for pivotal movement of said top rail and said posts toward said bottom rail to generally collapse said top rail toward said bottom rail,
a slide rail connected to said bottom rail,
at least one slide bearing for supportable therein of said slide rail, said slide bearing providing slidable movement of said slide rail and said guard rail parallel to a longitudinal axis of said patient support surface,
a release pin for securing said bottom rail in a selected position with respect to the longitudinal axis of said patient support surface, and
a release lever for retaining said top rail and said posts in a upright relation to said bottom rail and for releasing said pivot connection to permit collapsible movement of said top rail and said posts against said bottom rail,

10. A guard rail for use with a patient support surface having first and second sides, and at least one opening in a support surface head end said opening positioned to be adjacent to the chest of a patient, said opening extending outwardly generally from a longitudinal axis at the middle of the patient support surface head end and said opening terminating at said first side of said patient support surface the guard rail comprising:
a guard rail mounted adjacent said opening, said guard rail comprising:
a generally horizontal bottom rail,
a generally horizontal top rail,
a plurality of posts connecting said bottom rail and said top rail in spaced relation, and
a pivot connection between said post first end and said bottom rail and between said post second end and said top rail to provide collapsible movement of said top rail and said posts toward said bottom rail,
a slide rail connected to said bottom rail,
at least one slide bearing connected to a side of the patient support surface for supportably receiving therein said slide rail, said slide bearing permitting slidable movement therein of said slide rail and said guard rail connected thereto said slidable movement being parallel to a longitudinal axis of said patient support surface,
a release pin for securing said bottom rail in a selected position with respect to the longitudinal axis of said apparatus, and
a release lever for retaining said top rail and said posts in a upright relation to said bottom rail and for releasing said pivot connection to permit collapsible movement of said top rail and said posts against said bottom rail,

11. A method of responding to cardiac complaints of a patient comprising: receiving a patient in cardiac distress,
positioning said patient on a mobile exam table having an at least one void therein said void providing access to the patient's chest area,
inserting a filler section into said void, said filler section being movable between a first void filling position and second void opening position,
positioning a first and a second guard rail to maintain said patient on said table and to cover said void,
transporting said patient on said mobile exam table to a first location having an echocardiography device,
moving laterally said guard rail from the area of the void to allow access to said filler section,
moving said filler section from said void filling position to said void opening position to provide access to the patient's chest area,
conducting an echocardiography procedure on said patient,
inserting said filler section into said void,
repositioning laterally said guard rail, to a position adjacent said void and said filler section, and
transporting said patient to a second location.

12. The apparatus as claimed in claim 11 further comprising a void having a filler section for insertion therein.

13. The apparatus as claimed in claim 11 wherein said guard rail comprises a first rail and a second rail wherein said first rail collapses toward said second rail to allow access to said patient.

14. The apparatus as claimed in claim 11 wherein said guard rail is laterally slidable with respect to said table between first and second positions wherein said second position allows access to said access site to permit an echocardiographic procedure to be conducted on said patient
